(19) United States
(12) Patent Application Publication
(10) Pub. No.: US 2011/0012466 A1
(43) Pub. Date: Jan. 20, 2011

(54) FRACTIONAL SLOT WINDING CONFIGURATION FOR ELECTRIC MOTORS

(75) Inventors: ROLF BLISSENBACH, ROLLING HILLS ESTATES, CA (US); DANG DINH DANG, GARDEN GROVE, CA (US); ERIK HATCH, CYPRESS, CA (US); MICHAEL MILANI, RANCHO PALOS VERDES, CA (US); DAVID SCHAUER, NEW ULM, MN (US); JOHN WATTLEWORTH, MANKATO, MN (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/503,683

(22) Filed: Jul. 15, 2009

(51) Int. Cl. H02K 3/28; H02K 15/06

(52) U.S. Cl. 310/195; 29/596

(57) ABSTRACT

Methods and apparatus are provided for stator assembly for use with an electric motor assembly. The stator assembly includes, but is not limited to a stator core that has an inner surface and a plurality of stator slots defined in the inner surface. A fractional slot winding having a plurality of conductors is coupled to the stator core. Each stator slot contains a group of the conductors arranged in a radially adjacent configuration. The groups of conductors in each of the stator slots together form a plurality of concentric rings of conductors. The conductors in each mixed group are arranged such that conductors carrying differing phases of electric current are arranged in a radially alternating configuration.

### STATEMENT REGARDING FEDERALLY SPONSORED RESEARCH OR DEVELOPMENT

This invention was made with Government support under Integrated Traction Drive System for HEV, PHEV, FCV (DE-FC26-07NT43123), awarded by the US-Department of Energy. The Government has certain rights in this invention.

### TECHNICAL FIELD

The technical field generally relates to electric motors, and more particularly relates to stator assemblies for use with electric motors.

### BACKGROUND

In recent years, advances in technology have led to substantial changes in the design of automobiles. One of these changes involves the complexity, as well as the power usage, of various electrical systems within automobiles, including alternative fuel vehicles. For example, alternative fuel vehicles such as hybrid vehicles often use electrochemical power sources, such as batteries, ultracapacitors, and fuel cells, to power the electric traction machines (or electric motors) that drive the wheels, sometimes in addition to another power source, such as an internal combustion engine.

Such electric motors typically include a rotor assembly that rotates on a shaft within a stationary stator assembly. The rotor and stator assemblies each generate magnetic fields that interact with each other to cause the rotor assembly to rotate and produce mechanical energy.

The stator assembly typically includes a stator core having multitude of ferromagnetic annular layers (or laminations) arranged as a stack. Each lamination has several openings that, when aligned, form axial pathways or stator slots that extend through the length of the stator core. Conductive elements such as rods, wires, or the like, typically made from copper or a copper alloy, are wound around the stator core through these stator slots. Current passing through these conductors driven by a power source such as a battery or fuel cell generates electromagnetic flux that can be modulated as needed to control the speed of the motor.

Each stator slot houses a group of individual conductors arranged adjacent to one another in a radial direction with respect to the stator core. The groups, taken together, form concentric rings of conductors. The groups of conductors in each stator slot are electrically connected to groups of conductors in other stator slots. All of the conductors of the stator assembly are collectively referred to as a winding.

Conventionally, the winding carries more than one phase of electric current. For example, some electric motors use a three-phase electric current. In such motors, there are three different electric currents running through the winding, each current being separated in phase from each of the other currents by 120 degrees. Each phase of electric current has its own set of interconnected conductors wound around the stator core through the stator slots. Typically, the conductors which carry electric current at the same phase are distributed over an integer number of slots (1,2,3 etc.). This type of winding is referred to as an integer slot winding.

In some electric motors, some or all of the stator slots house conductors that carry electric current at differing phases. For example, a single stator slot may house conductors that carry electric current at a first phase and may also house conductors that carry electric current at a second phase. Such a winding is referred to as a fractional slot winding because the conductors of a single phase occupy a fractional number of slots, for example, 1.5 slots per phase per magnetic pole of the rotor assembly.

In conventional fractional slot windings, when conductors carrying differing phases of electric current are disposed in a shared stator slot (a “mixed group of conductors”), the conductors are segregated based on the phase of electric current that they carry. This is illustrated in FIG. 3 where each stator slot houses six radially adjacent conductors having three conductors that carry current at a first phase and three conductors that carry current at a second phase. The three first-phase conductors are arranged together in a first sub-group, the three second-phase conductors are arranged together in a second sub-group, and the first and second sub-groups are placed radially adjacent one another to form the mixed group of conductors. The conductors of the first and the second sub-groups are then connected to corresponding phase conductors in different stator slots.

The segregation of conductors in a mixed group of conductors based on the phase of electric current that they carry greatly complicates the connection configuration of all conductors in the winding. This is illustrated in FIG. 3 which depicts the electrical connections between same-phase conductors in different stator slots, one of which houses a mixed group of conductors. This illustration presents a simplified view of a stator assembly and shows only a three electrical connections.

As shown in FIG. 3, the electrical connections must span three concentric rings of conductors in order to reach the next set of same-phase conductors. The same is true for every electrical connection between every conductor in the illustrated fractional slot winding regardless of whether the conductor is in a mixed group of conductors. This configuration complicates the assembly process for the fractional slot winding, consumes more material than is necessary, and increases the overall length of the stator assembly because each connection must reach across 3 concentric rows of conductors and must cross over a corresponding number of other electrical connections.

Accordingly, in a fractional slot winding, it is desirable to simplify the connection configuration. In addition, it is desirable to arrange the conductors in a mixed group of conductors in a configuration that facilitates a simplified connection configuration. Furthermore, other desirable features and characteristics will become apparent from the subsequent detailed description and the appended claims, taken in conjunction with the accompanying drawings and the foregoing technical field and background.

### SUMMARY

An apparatus and method for making a stator assembly for use with an electric motor is disclosed herein. In a first non limiting embodiment, a stator assembly includes, but is not limited to, a stator core having an inner surface and a plurality of stator slots defined in the inner surface. A fractional slot winding having a plurality of conductors is coupled to the stator core. Each stator slot contains a group of the conductors arranged in a radially adjacent configuration. The groups of conductors together form a plurality of concentric rings of conductors. A plurality of the groups are mixed groups, and the conductors in each mixed group are arranged such that conductors carrying differing phases of electric current are arranged in a radially alternating configuration.

In a second non-limiting embodiment, an electric motor assembly configured for use with a vehicle includes, but is not limited to a rotor and a stator assembly that is magnetically coupled to the rotor. The stator assembly includes, but is not limited to, a stator core having an inner surface and a plurality of stator slots defined in the inner surface. A fractional slot winding having a plurality of conductors is coupled to the stator core. Each stator slot contains a group of the conductors arranged in a radially adjacent configuration. The groups of conductors together form a plurality of concentric rings of conductors. A plurality of the groups are mixed groups, and the conductors in each mixed group are arranged such that conductors carrying differing phases of electric current are arranged in a radially alternating configuration.

In a third, non-limiting example, a method of manufacturing a stator assembly for use with an electric motor assembly includes, but is not limited to, providing a stator core having a generally annular configuration, an inner surface forming an internal cavity in the stator core and a plurality of slots extending axially within the inner surface, and providing a plurality of conductors. The method also includes positioning groups of the conductors in each of the stator slots and arranging the conductors in each group of conductors in a radially adjacent configuration such that each group of conductors together form a plurality of concentric rings of conductors. The method further includes arranging the conductors in each mixed group such that conductors of differing phases of electric current are arranged in a radially alternating configuration.

### DESCRIPTION OF THE DRAWINGS

One or more embodiments will hereinafter be described in conjunction with the following drawing figures, wherein like numerals denote like elements, and

FIG. 1 is a schematic diagram of an exemplary vehicle illustrating a manner in which a non-limiting example of an electric motor including a stator assembly made in accordance with the present disclosure is integrated with various sub-components of the vehicle;

FIG. 2 is an exploded view of a non-limiting example of an electric motor having a rotor assembly and a stator assembly made in accordance with the teachings of the present disclosure;

FIG. 3 is a simplified side view illustrating a prior art configuration for a three-phase fractional slot winding;

FIG. 4 is a schematic cross-sectional view illustrating a non-limiting example of a multi-phase fractional slot winding in accordance with the teachings of the present disclosure:

FIG. 5. is a schematic cross-sectional view illustrating a non-limiting example of a three-phase fractional slot winding in accordance with the teachings of the present disclosure.

FIG. 6 is a schematic view illustrating a first non-limiting example of an electrical connection configuration between conductors in different stator slots in a multi-phase fractional slot winding according to the teachings of the present disclosure;

FIG. 7 is a schematic view illustrating a second non-limiting example of an electrical connection configuration between conductors in different stator slots in a multi-phase fractional slot winding according to the teachings of the present disclosure; and

FIG. 8 is a flow chart illustrating a non-limiting example of a method for making a fractional slot winding in accordance with the teachings of the present disclosure.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

As used herein, the term “open stator slot” refers to a stator slot wherein the width of the radial opening into the slot from an internal cavity of the stator core is substantially the same as a width of the remainder of the slot when measured in a generally circumferential direction about the central axis of the stator core.

As used herein, the term “semi-closed stator slot” refers to a stator slot wherein the width of the radial opening into the slot from an internal cavity of the stator core is less than the width of the remainder of the slot when measured in a generally circumferential direction about the central axis of the stator core.

As used herein, the term “three-phase electricity” refers to a common method of transmitting electric power wherein three circuit conductors carry three alternating currents of the same frequency which reach their instantaneous peak values at different times. Taking one conductor as the reference, the other two currents are delayed in time by one-third and two-thirds of one cycle of the electrical current. This delay between phases has the effect of giving generally constant power transfer over each cycle of the current.

As used herein, the term “multi-phase electricity” refers to a method of transmitting electric power wherein more than three conductors carry a respective number of alternating currents of the same frequency which reach their instantaneous peak values at different times. If the number of alternating currents is N, then each of the currents will be delayed in time from one another by 1/N^{th} of a cycle of electric current. For example, in a system having 5 phases and a 360 degree cycle, the instantaneous peak value for each of the 5 electric currents in each of the five conductors will be offset from one another by 72 degrees.

As used herein, the term “winding” refers to the conductors that are inserted into stator slots and that are interconnected to wrap around the stator core for the purpose of carrying electric current through the stator core to generate magnetic flux which is used to rotate a rotor in an electric motor.

As used herein, the term “three-phase winding” refers to a winding of electric conductors wrapped around a stator core that is configured to deliver three-phase electricity.

As used herein, the term “multi-phase winding” refers to a winding of electric conductors wrapped around a stator core that is configured to deliver multi-phase electricity.

As used herein, the term “integer slot winding” refers to a winding of electric conductors wrapped around a stator core wherein the number of slots per pole per phase is an integer. For example, if a winding has two slots per pole per phase, then the number of slots per pole that will be dedicated to carrying conductors of one of the phases of electric current will be two whole slots.

As used herein, the term “fractional slot winding” refers to a winding of electric conductors wrapped around a stator core wherein the number of slots per pole per phase is not an integer, but is, instead, a fraction. For example, if a winding has 1.5 slots per pole per phase, then the number of slots per pole that will be dedicated to carrying conductors of one of the phases will be one and a half slots. When a winding is configured for fractional slot winding, then some or all of the slots will receive conductors carrying electric current at different phases.

As used herein, the term “conventional winding” refers to a winding that is configured to carry three-phase electric current and which is further configured such that the number of slots per pole per phase is an integer. The term “conventional winding” shall be used interchangeably herein with the term “three-phase integer slot winding”.

As used herein, the term “multi-phase fractional slot winding” refers to a winding that is configured to carry multi-phase electric current and which is further configured such that the number of slots per pole per phase is a fraction, not an integer.

As used herein, the term “group of conductors” refers to all of the conductors disposed within a stator slot.

As used herein, the term, “mixed group of conductors” refers to a group of conductors wherein at least one of the conductors in the group carries electric current at a phase that differs from at least one of the other conductors in the group.

One non-limiting solution to the fractional slot winding problem discussed above is to interleaf differently phased conductors within mixed groups of conductors such that the differently phased conductors are arranged in a radially alternating pattern within each mixed group of conductors. For example, if a mixed group of conductors contains two conductors carrying electric current at a first phase (a “first-phase conductor”) and two conductors carrying electric current at a second phase (a “second-phase conductor”), then the conductors within such a mixed group of conductors will be arranged in a first-phase, second-phase, first-phase, second-phase pattern.

Arranging the differently phased conductors in an alternating pattern permits all of the electrical conductors in a fractional slot winding to be connected to conductors in an adjacent concentric row. This reduces, and in some configurations eliminates the need to extend electrical connections over multiple rows of conductors. Further, such connection configuration reduces the length of each electrical connection, reduces the severity of the bend and twist angle of each connection, and also reduces the complexity of assembly of the fractional slot winding.

A greater understanding of the apparatus and method disclosed herein can be obtained through a review of the illustrations accompanying this disclosure together with a review of the detailed description that follows.

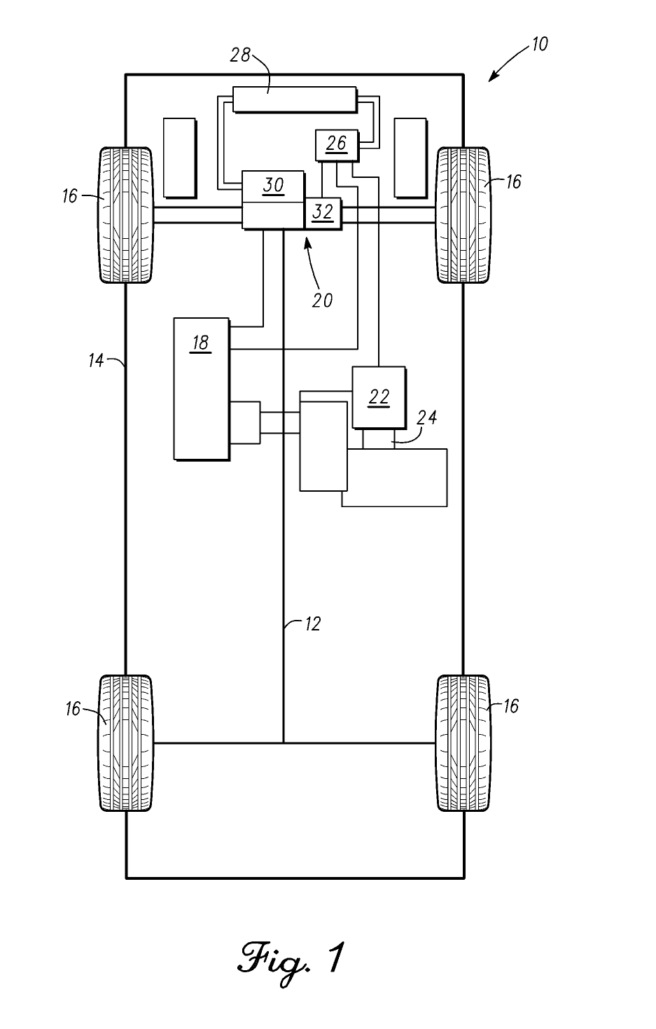

FIG. 1 is a schematic diagram of an exemplary vehicle 10, such as an automobile. The vehicle 10 includes a chassis 12, a body 14, four wheels 16, and an electronic control system (or electronic control unit (ECU)) 18. The body 14 is arranged on the chassis 12 and substantially encloses the other components of the vehicle 10. The wheels 16 are each rotationally coupled to the chassis 12 near a respective corner of the body 14.

The vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The vehicle 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

In the exemplary embodiment illustrated in FIG. 1, the vehicle 10 is a hybrid vehicle, and further includes an actuator assembly (or powertrain) 20, a battery array 22, a battery state of charge (SOC) system 24, a power electronics bay (PEB) 26, and a radiator 28. The actuator assembly 20 includes an internal combustion engine 30 and an electric motor/generator (or electric traction machine) system (or assembly) 32. The battery array 22 is electrically coupled to PEB 26 and, in one embodiment, comprises a lithium ion (Li-ion) battery including a plurality of cells, as is commonly used. Electric traction machine 32 typically includes a plurality of electric components, including stator and rotor assemblies. In some examples, the stator assembly includes an annular core containing a multitude of annular core laminations, and a plurality of conductors (or conductive elements) extending through these laminations.

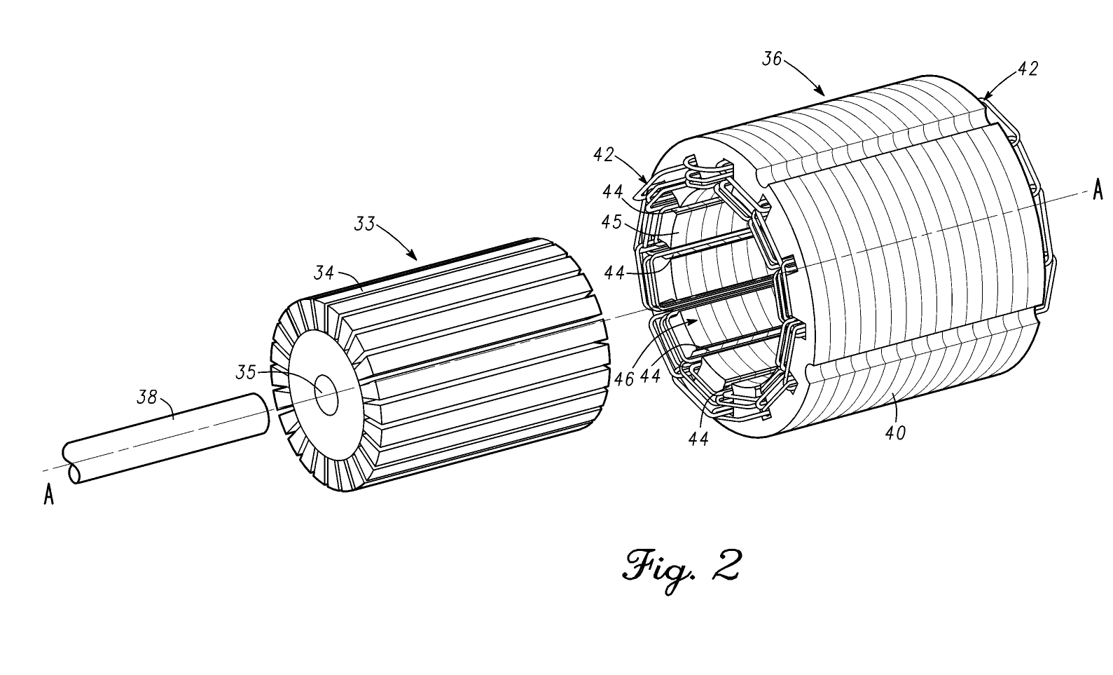

FIG. 2 is a simplified exploded view of a portion of electric motor 32, depicting a rotor assembly 33, a stator assembly 36 and a shaft 38. It should be noted that many detailed elements commonly found in such an electric machine have been omitted for greater clarity.

Rotor assembly 33 includes a rotor body 34 having a generally cylindrical configuration and a substantially circular cross section across central axis AA which runs longitudinally through rotor body 34. Rotor body 34 includes a cavity 35 extending throughout the entire longitudinal length of rotor body 34 and is configured to receive shaft 38.

Rotor assembly 33 also includes a plurality of permanent magnets (not shown) disposed within magnet cavities (not shown) that are arranged in a ring around rotor body 34. The magnet cavities extend axially through rotor body 34. The permanent magnets are oriented within the magnet cavities so each magnet's poles are positioned proximate an axial end of rotor body 34. The magnets are arranged such that their poles alternate between north and south such at both axial ends of the rotor body 34, each north pole is neighbored on two sides by a south pole and each south pole is neighbored on two sides by a north pole.

Shaft 38 is fixedly coupled to rotor body 34, and in some embodiments, is configured to extend through cavity 35 such that a portion of shaft 38 protrudes beyond both axial ends of rotor body 34. When rotor assembly 33 is positioned within stator assembly 36, a potion of shaft 38 may protrude beyond an axial end of stator assembly 36. The portion of shaft 38 that extends beyond an axial end of stator assembly 36 may be rotatably coupled to a housing that houses electric motor 32 (not shown) and thereby rotatably supports rotor assembly 33 when rotor assembly 33 is disposed within stator assembly 36. An opposite end of shaft 38 is used to transmit torque generated by the rotation of rotor assembly 33 within stator assembly 36.

Stator assembly 36 includes a stator core 40 and a winding 42. Stator core 40 includes multiple stator slots 44 defined within a surface 45 that forms an internal cavity 46 within stator core 40. Internal cavity 46 has a substantially circular cross section within stator core 40. Central axis AA runs axially through an approximate center of internal cavity 46. Stator slots 44 extend axially through stator core 40 and are aligned with central axis AA. Internal cavity 46 is configured to receive rotor assembly 33 and rotor assembly 33 is configured to rotate within internal cavity 46.

Winding 42 includes a plurality of conductors, commonly comprising copper or a copper alloy. Multiple conductors are disposed within each stator slot 44. Each of the multiple conductors extends along an entire axial length of one stator slot 44 and protrudes beyond both axial ends of the stator slot 44. The protruding portions are bent and/or twisted towards a second conductor that protrudes out of an axial end of a second stator slot 44, and then electrically connected thereto, such as by welding or by such other method or mechanical means effective to electrically connect the two conductors. The positioning of multiple conductors in each slot and the bending and/or twisting of their respective ends to electrically connect to other conductors in other slots continues around the circumference of stator core 40 until each of the stator slots 44 contains a plurality of the conductors, thus forming winding 42. In some embodiments, only a single conductor may be positioned in each stator slot 44 to form winding 42. Winding 42 may have a plurality of configurations, including, but not limited to, a three-phase winding, a multi-phase winding, and a fractional slot winding coupled with either a three-phase winding or a multi-phase winding.

During operation, electric current flows through winding 42. As the current flows, it generates a magnetic flux that interacts with flux emanating from the permanent magnets housed in rotor assembly 33. The flux interaction between stator assembly 36 and rotor assembly 33 causes rotor assembly 33 to rotate with shaft 38 about axis A-A, generating mechanical energy thereby.

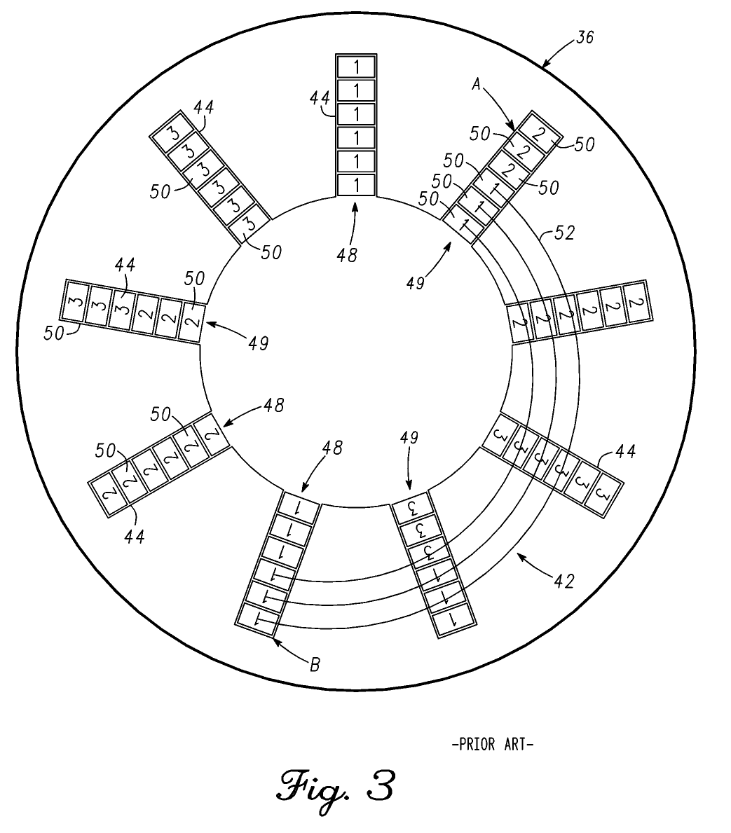

FIG. 3 is a side view illustrating an axial end of a simplified example of a prior art stator assembly 36 having a stator core 40 that has nine stator slots 44. Each stator slot 44 contains a single group of conductors 48. Each group of conductors 48 includes six conductors 50 positioned radially adjacent one another. In other embodiments, stator core 40 may have any suitable number of stator slots 44 and each group of conductors 48 may have any suitable number of conductors 50.

The conductors 50 in each group of conductors 48 are electrically connected to other conductors 50 in other groups of conductors 48 via electrical connections 52. Electrical connections 52 may comprise a portion of the two connected conductors 50 and a weld joint. Alternatively, an additional conductor such as a wire or a mechanical fastener that is configured to conduct electricity may be employed to connect the two conductors 50. In still other embodiments, any other means effective to electrically connect the two individual conductors 50 may be employed.

In FIG. 3, winding 42 is configured as a three-phase fractional slot winding having 1.5 slots per phase per magnetic pole. Each conductor 50 in each stator slot 44 has been annotated with a digit to indicate the phase of the electric current carried by the respective conductor.

For ease of illustration, only a small portion of the electrical connections 52 are depicted. It should be understood that each conductor 50 in each stator slot 44 of stator assembly 36 is connected by an electrical connection 52 to at least one other conductor 50 in a different stator slot 44.

As illustrated, different phase conductors 50 in each mixed group of conductors 49 are segregated by phase. For example, in the mixed group of conductors 49 labeled with the letter “A”, the three conductors 50 closest to internal cavity 46 carry electric current at a first phase and the three conductors 50 furthest from internal cavity 46 carry electric current at a second phase. The first-phase conductors of mixed group of conductors “A” are connected to first-phase conductors 50 of group of conductors “B” by electrical connections 52. As electrical connections 52 span between groups “A” and “B”, each one spans three concentric rings of conductors in order to reach the corresponding conductors in the next stator slot 44 in the series of stator slots that carry first-phase conductors. Each of the other conductors 50 wound around stator core 40 must also span three concentric rings of conductors to reach corresponding same-phased conductors. The spanning of three concentric rings of conductors is problematic for the reasons set forth above.

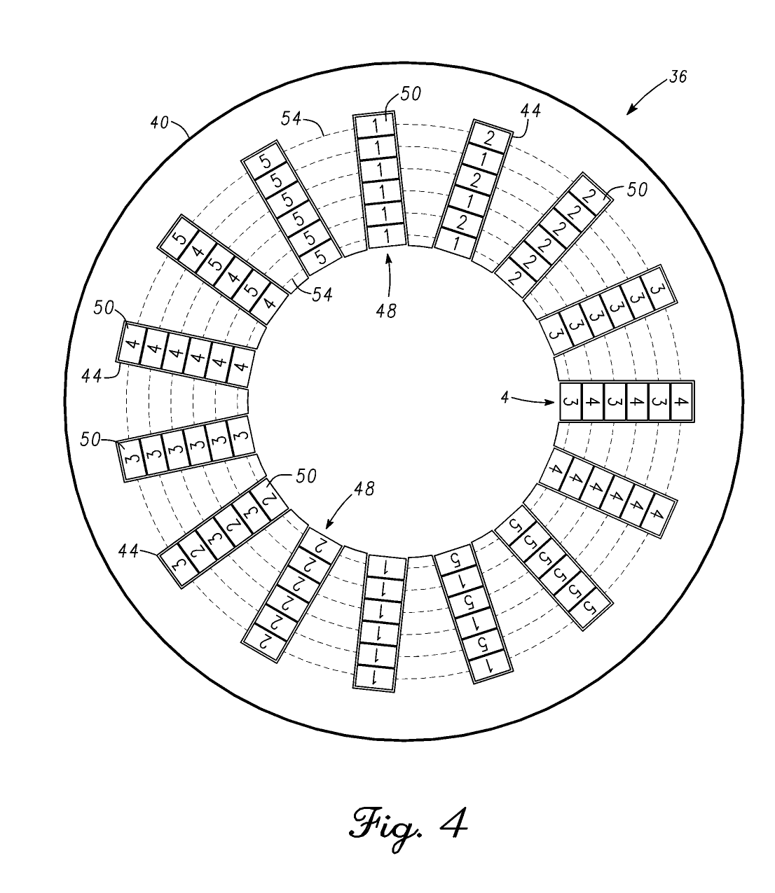

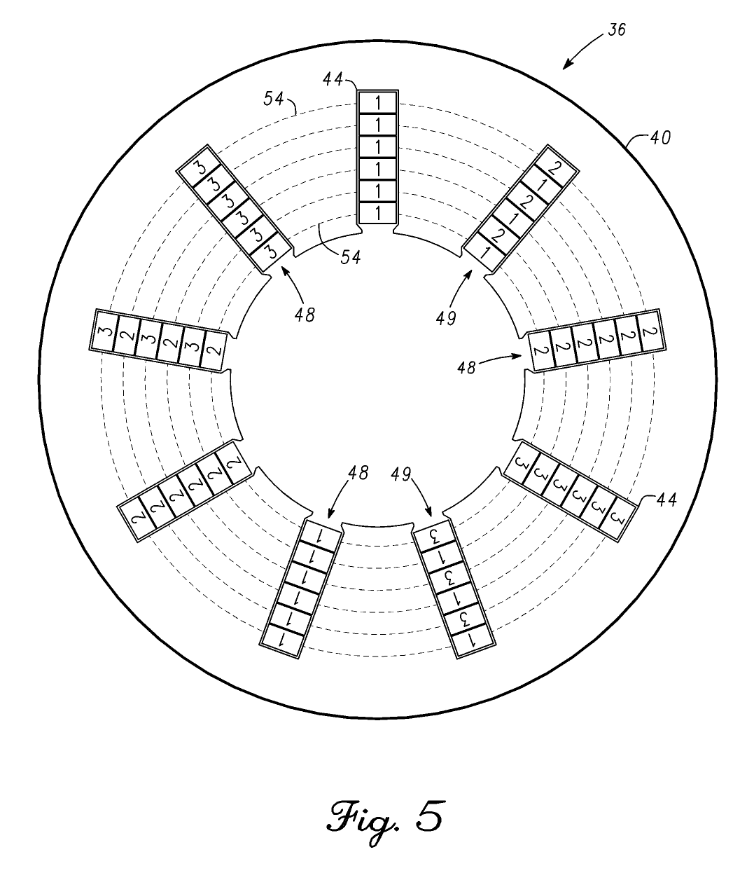

FIGS. 4 and 5 are simplified cross-sectional views that illustrate non-limiting embodiments of stator assemblies 36 according to the teachings of the present disclosure. FIG. 4 illustrates a multi-phase fractional slot winding having five phases and 1.5 slots per phase per magnetic pole and FIG. 5 illustrates a three-phase fractional slot winding having 1.5 slots per phase per magnetic pole. As illustrated in FIGS. 4 and 5, each stator slot 44 houses a group of conductors 48 or a mixed group of conductors 49, each comprising six conductors 50. All of the conductors 50 in all of the stator slots 44, when taken together, form six concentric rings 54 around internal cavity 46. In other embodiments, the number of conductors 50 and the corresponding number of consecutive rings 54 may vary.

The mixed groups of conductors 49 in FIGS. 4 and 5 are arranged differently than the mixed groups of conductors 49 of FIG. 3. In FIGS. 4 and 5, instead of segregating different phase conductors 50, the different phase conductors are interleafed with one another in an alternating pattern such that a conductor of one phase is positioned radially adjacent a conductor of a different phase. To illustrate this, each conductor 50 in each stator slots 44 in FIGS. 4 and 5 are annotated with a digit that correspond to the phase of electric current carried by the respective conductors.

FIGS. 4 and 5 also illustrate that the teachings of the present disclosure are applicable to differently configured stator cores 40. The stator core 40 illustrated in FIG. 4 has stator slots 44 that are configured as open stator slots. The stator core 40 illustrated in FIG. 5 has stator slots 44 that are configured as semi-closed stator slots. Other stator slot configurations may also be compatible with the teachings of the present disclosure.

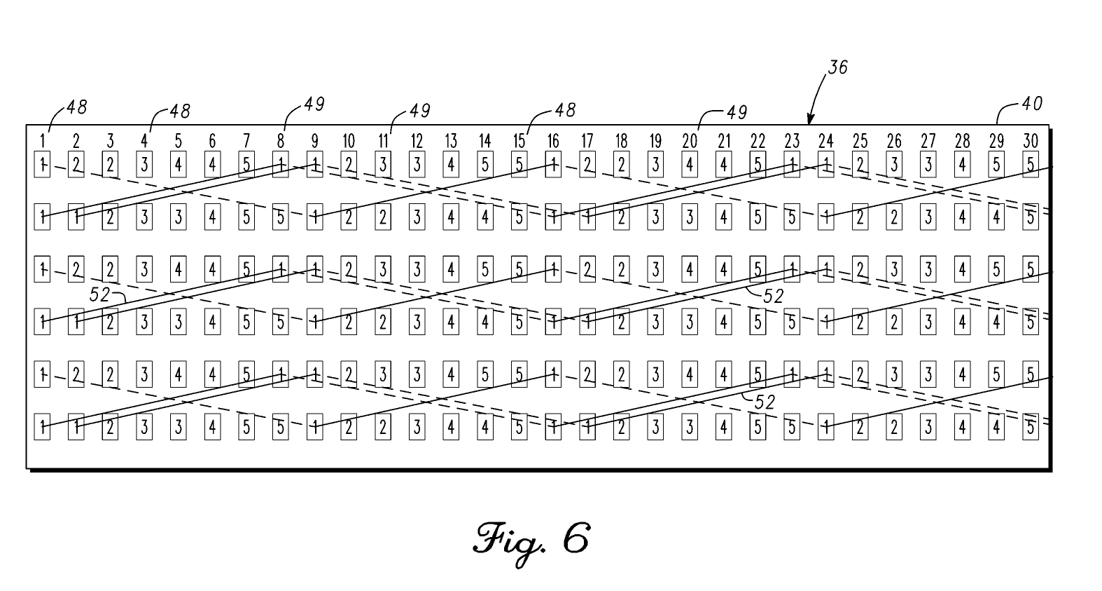

FIG. 6 is a schematic view illustrating a simplified electrical connection between some of the conductors 50 in a multi-phase fractional slot winding having 1.5 slots per phase per magnetic pole. The stator assembly 36 schematically depicted in FIG. 6 represents conductors housed in thirty different stator slots. The numbers one through thirty are positioned above each group of conductors for ease of reference. This depiction is merely illustrative in nature. In other embodiments, stator assemblies 36 may have any suitable number of stator slots.

As before, annotations are provided in each group of conductors 48 and each mixed group of conductors 49 that correspond to the phase of electric current carried by each conductor in the respective group. For example, mixed group of conductors 49 housed within stator slot number eight includes alternating conductors carrying electric current at a first phase and at a fifth phase, as indicated by the alternating pattern of ones and fives positioned within each conductor.

In FIG. 6, the electrical connections 52 between the conductors of differing stator slots are illustrated in both solid and phantom lines. It should be understood that the view presented in FIG. 6 is a schematic illustration of a proximal axial end of stator assembly 36. It should also be understood that a distal axial end disposed opposite the proximal axial side is not visible in FIG. 6. The electrical connections 52 illustrated in solid lines are those that connect conductors which protrude out of the proximal axial end of stator core 40. The electrical connections 52 illustrated in phantom lines are those that connect conductors which protrude out of the distal axial end and that are therefore obstructed from view by stator core 40.

As illustrated in FIG. 6, each electrical connection 52 connects conductors that are in adjacent concentric rings (illustrated as rows in FIG. 6). For example, each conductor in stator slot one is connected to a same-phase conductor in stator slot eight that is positioned in an adjacent concentric ring. Configuring the electrical connections 52 in this manner avoids the need to cross over multiple concentric rings of conductors and, by contrast with the configuration depicted in FIG. 3, simplifies the assembly of stator assembly 36.

FIG. 6 illustrates an oscillating pattern of electrical connection between the conductors of stator assembly 36. Each of the conductors positioned in stator slot one are connected to a corresponding conductor in stator slot eight that is one adjacent concentric ring above the conductors of stator slot 1. Conversely, each of the conductors positioned in stator slot eight are connected to a corresponding conductor in stator slot sixteen that is one adjacent concentric ring below the conductors of stator slot eight. This pattern of connecting to the next higher concentric ring and then to the next lower concentric ring forms an oscillating pattern that propagates around the entire stator core 40.

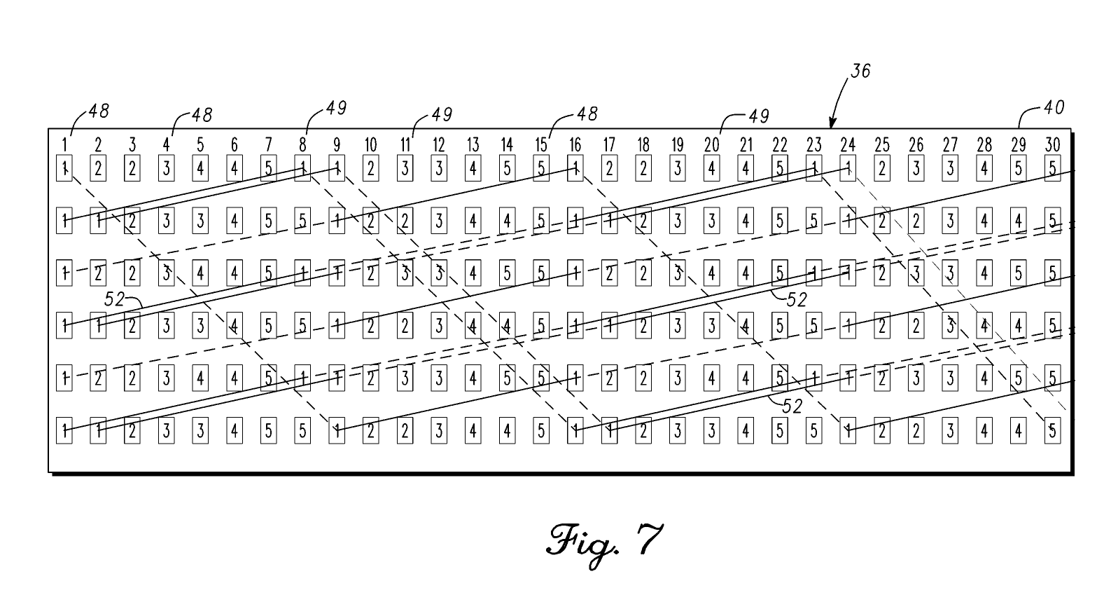

FIG. 7 is a schematic view illustrating an alternate configuration for the electrical connection between conductors 50 in a multi-phase fractional slot winding having 1.5 slots per phase per magnetic pole. In FIG. 7, each conductor is electrically connected to a correspondingly phased conductor disposed in the next higher adjacent concentric row. In the aggregate, the electrical connections form a spiral pattern that propagates around the entire stator core 40. Other patterns are possible.

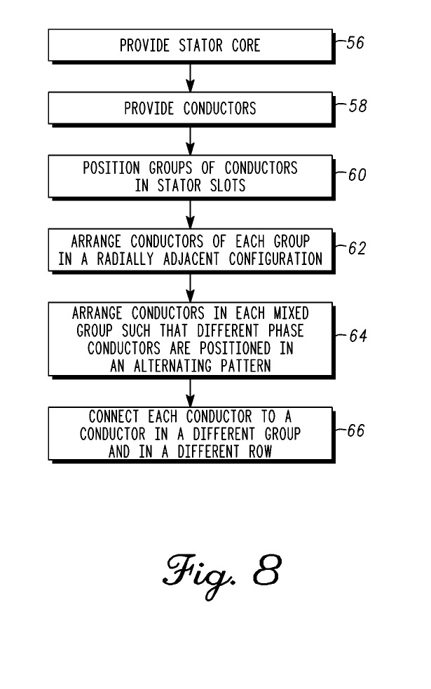

FIG. 8 is a flow chart that illustrates a non-limiting example of a method for manufacturing a stator assembly in accordance with the teachings of the present disclosure. At box 56, stator core 40 is provided. Stator core 40 may have any suitable dimension and may include any suitable number of stator slots 44. At box 58, a suitable number of conductors 50 needed to form winding 42 are provided. In the examples shown above, each stator slot 44 houses six conductors 50. In other examples, a greater or lesser quantity of conductors may be housed in each stator slot without departing from the teachings of the present disclosure.

At box 60, conductors 50 are positioned within stator slots 44 and arranged in groups (i.e., groups of conductors 48 and/or mixed groups of conductors 49). If stator core 40 has open slots, then conductors 50 may be axially inserted into internal cavity 46 and then radially inserted into a respective stator slot 44. If stator core 40 has semi-closed stator slots, then each conductor 50 must be axially inserted into each stator slot 44 from an axial end of stator core 40. The groups of conductors 50 are arranged in radially extending groups within each stator slot 44 form a plurality of concentric rings 54 that correspond in number to the number of conductors in each group.

At box 62, conductors 50 are arranged adjacent to one another in a single line that extends in the radial direction of stator core 40. At box 64, the conductors 50 in each mixed group of conductors 49 are positioned in an alternating pattern with each conductor 50 carrying a different phase of electric current than each adjacent conductor 50. It should be understood that the steps illustrated at boxes 60, 62 and 64 may each be performed simultaneously.

At box 66, a conductor 50 disposed in a stator slot 44 and positioned in one of the concentric rings 54 is electrically connected to a same-phase conductor 50 disposed in a different stator slot 44 and positioned in an adjacent concentric ring 54. This step is repeated for each conductor 50 in each stator slot 44. This step may also include bending and twisting the ends of each electrically connected pair of conductors 50 towards one another. When each conductor 50 is electrically connected to another conductor 50, winding 42 is complete.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A stator assembly for use with an electric motor assembly, the stator assembly comprising:
a stator core having an inner surface and a plurality of stator slots defined in the inner surface; and
a fractional slot winding comprising a plurality of conductors coupled to the stator core,
wherein each of the stator slots contains a group of the conductors arranged in a radially adjacent configuration, wherein the group of conductors from each of the stator slots together form a plurality of concentric rings of conductors, wherein a plurality of the groups comprise mixed groups, and wherein the conductors in each mixed group are arranged such that the conductors carrying differing phases of electric current are arranged in a radially alternating configuration.

2. The stator assembly of claim 1 wherein each conductor in each stator slot is electrically connected to a conductor that is disposed in a different stator slot and that is positioned in an adjacent concentric ring of conductors.

3. The stator assembly of claim 2 wherein the conductors in each stator slot are connected to the conductors in other stator slots in an oscillating pattern that propagates around the stator core.

4. The stator assembly of claim 2 wherein the conductors in each stator slot are connected to the conductors in other stator slots in a spiral pattern that propagates around the stator core.

5. The stator assembly of claim 1 wherein the conductors in a first mixed group are arranged in a radially alternating configuration that is offset by one concentric ring from a radially alternating configuration of a consecutive mixed group having a same-phase conductor as the first mixed group.

6. The stator assembly of claim 1 wherein the plurality of stator slots comprise open stator slots.

7. The stator assembly of claim 1 wherein the plurality of stator slots comprise semi-closed stator slots.

8. The stator assembly of claim 1 wherein the fractional slot winding comprises a three-phase fractional slot winding.

9. The stator assembly of claim 1 wherein the fractional slot winding comprises a multi-phase fractional slot winding.

10. An electric motor assembly configured for use with a vehicle, the electric motor assembly comprising:
a rotor; and
a stator assembly magnetically coupled to the rotor, the stator assembly comprising:
a stator core having an inner surface and a plurality of stator slots defined in the inner surface; and
a fractional slot winding comprising a plurality of conductors coupled to the stator core,
wherein each of the stator slots contains a group of the conductors arranged in a radially adjacent configuration, wherein the group of conductors from each of the stator slots together form a plurality of concentric rings of conductors, wherein a plurality of the groups comprise mixed groups, and wherein the conductors in each mixed group are arranged such that the conductors carrying differing phases of electric current are arranged in a radially alternating configuration.

11. The electric motor assembly of claim 10 wherein each conductor in each stator slot is electrically connected to a conductor that is disposed in a different stator slot and that is positioned in an adjacent concentric ring of conductors.

12. The electric motor assembly of claim 11 wherein the conductors in each stator slot are connected to the conductors in other stator slots in an oscillating pattern that propagates around the stator core.

13. The electric motor assembly of claim 11 wherein the conductors in each stator slot are connected to the conductors in other stator slots in a spiral pattern that propagates around the stator core.

14. The electric motor assembly of claim 10 wherein the conductors in a first mixed group are arranged in a radially alternating configuration that is offset by one concentric ring from a radially alternating configuration of a consecutive mixed group having a same-phase conductor as the first mixed group.

15. The electric motor assembly of claim 10 wherein the plurality of stator slots comprise open stator slots.

16. The electric motor assembly of claim 10 wherein the plurality of stator slots comprise semi-closed stator slots.

17. The electric motor assembly of claim 10 wherein the fractional slot winding comprises a three-phase fractional slot winding.

18. The electric motor assembly of claim 10 wherein the fractional slot winding comprises a multi-phase fractional slot winding.

19. A method of manufacturing a stator assembly for use with an electric motor assembly, the method comprising the steps of:
providing a stator core having a generally annular configuration, an inner surface forming an internal cavity in the stator core and a plurality of slots extending axially within the inner surface;
providing a plurality of conductors;
positioning groups of the conductors in each of the stator slots;
arranging the conductors in each group of conductors in a radially adjacent configuration such that each group of conductors together forms a plurality of concentric rings of conductors; and
arranging the conductors in each mixed group such that the conductors of differing phases of electric current are arranged in a radially alternating configuration.

20. The method of claim 19 further comprising the step of connecting each conductor in each group of conductors to a conductor that is disposed in a different group of conductors and that is radially offset by one concentric ring.
